(19) United States
(12) Patent Application Publication
(10) Pub. No.: US 2020/0118474 A1
(43) Pub. Date: Apr. 16, 2020

(54) GATE DRIVING CIRCUITY, METHOD FOR DRIVING THE SAME AND DISPLAY DEVICE

(71) Applicants: CHONGQING BOE OPTOELECTRONICS TECHNOLOGY CO., LTD., Chongqing (CN); BOE TECHNOLOGY GROUP CO., LTD., Beijing (CN)

(72) Inventors: Yuanbo ZHANG, Beijing (CN); Shuai CHEN, Beijing (CN); Rui WANG, Beijing (CN); Pengcheng FU, Beijing (CN); Wenlin MEI, Beijing (CN); Xiaolin WANG, Beijing (CN); Shouqiang ZHANG, Beijing (CN)

(73) Assignees: CHONGQING BOE OPTOELECTRONICS TECHNOLOGY CO., LTD., Beijing (CN); BOE TECHNOLOGY GROUP CO., LTD., Beijing (CN)

(21) Appl. No.: 16/329,986

(22) PCT Filed: Jul. 3, 2018
(86) PCT No.: PCT/CN2018/094225

§ 371 Date: Mar. 1, 2019

(30) Foreign Application Priority Data
Aug. 30, 2017 (CN) 201710764685.0

(51) Int. Cl. G09G 3/20

(52) U.S. Cl. CPC G09G 3/20; G09G 2310/08; G09G 2310/0267; G09G 2300/0408; G09G 2300/08; G09G 2300/0426; G09G 2310/0286

(57) ABSTRACT

A gate driving circuitry, a method for driving the same and a display device are provided. The gate driving circuitry includes N gate driving units and N groups of clock signal lines, and an n-th gate driving unit is correspondingly connected to an n-th group of clock signal lines, where N is an integer greater than 1, and n is a positive integer less than or equal to N. Each group of clock signal lines includes 2a clock signal lines, where a is equal to 1, or a is an even number; each of the gate driving units includes at least one shift register module; and each shift register module in the n-th gate driving unit is connected to the n-th group of clock signal lines.

### CROSS-REFERENCE TO RELATED APPLICATION

This application claims a priority to Chinese Patent Application No. 201710764685.0 filed on Aug. 30, 2017, the disclosure of which is incorporated in its entirety by reference herein.

### TECHNICAL FIELD

The present disclosure relates to the field of display driving technologies, in particular to a gate driving circuitry, a method for driving the same and a display device.

### BACKGROUND

A Gate Driver On Array (GOA) circuitry can achieve a shift register function, which is referred to as a gate driver circuitry on an array substrate. The GOA circuitry is configured to provide a pulse signal of a certain width for each gate line line by line in a frame, the time width is generally one or several times longer than the charging time allocated for each line of gate lines, and a waveform of the pulse signal is usually a square wave. A GOA unit includes a plurality of shift register units that are cascaded with each other, and each of the shift register units may output a pulse signal to its corresponding gate line in a display time of each frame.

However, a capacitive load of the shift register unit applied onto one of the clock signal lines connected thereto accounts for the vast majority of a capacitive load on the clock signal line, and an overlapping capacitance between the clock signal line and the other clock signal lines and an overlapping capacitance between the clock signal line and other signal lines account for only a small portion of the capacitive load on the clock signal line. Therefore, the clock signal lines in the conventional GOA circuitry have high power consumption.

### SUMMARY

In a first aspect, a gate driving circuitry is provided according to embodiments of the present disclosure. The gate driving circuitry includes: N gate driving units and N groups of clock signal lines, where an n-th one of the gate driving units is correspondingly connected to an n-th group of clock signal lines, where N is an integer greater than 1, and n is a positive integer less than or equal to N. Each group of clock signal lines includes 2a clock signal lines, where a is equal to 1, or a is an even number; each of the gate driving units includes at least one shift register module; and each of the at least one shift register module included in the n-th gate driving unit is connected to the n-th group of clock signal lines.

In some possible embodiments of the present disclosure, each shift register module includes 2a shift register units that are sequentially cascaded, and each of the shift register units included in each shift register module in the n-th gate driving unit is correspondingly connected to one clock signal line in the n-th group of clock signal lines.

In some possible embodiments of the present disclosure, each shift register unit is configured to output a corresponding gate driving signal according to a clock signal inputted by the clock signal line connected to the shift register unit.

In some possible embodiments of the present disclosure, a is equal to 1, N is equal to 2, and the gate driving circuitry includes a first gate driving unit, a second gate driving unit, a first group of clock signal lines, and a second group of clock signal lines. The first group of clock signal lines includes a first clock signal line and a second clock signal line, and the second group of clock signal lines includes a third clock signal line and a fourth clock signal line. The first gate driving unit includes at least one shift register module, the second gate driving unit includes at least one shift register module, and each of the at least one shift register module includes a first shift register unit and a second shift register unit. The first shift register unit in each of the at least one shift register module of the first gate driving unit is connected to the first clock signal line, and the second shift register unit in each of the at least one shift register module of the first gate driving unit is connected to the second clock signal line. The first shift register unit in each of the at least one shift register module of the second gate driving unit is connected to the third clock signal line, and the second shift register unit in each of the at least one shift register module of the second gate driving unit is connected to the fourth clock signal line.

In some possible embodiments of the present disclosure, each shift register unit includes:

a pull-up node control circuit, that is respectively connected to an input end, a reset end, a pull-up node and a pull-down node, and is configured to control a potential of the pull-up node under the control of the input end, the reset end and the pull-down node;

a pull-down node control circuit, that is respectively connected to a high-level input end, the pull-up node, and the pull-down node, and is configured to control a potential of the pull-down node under the control of the pull-up node;

a storage capacitor circuit, having a first end connected to the pull-up node, and a second end connected to a gate driving signal input end; and

an output circuit, that is respectively connected to the pull-up node, the pull-down node, a clock signal input end, a low level input end, and a gate driving signal output end, and is configured to control whether the gate driving signal output end is connected to the clock signal input end under the control of the pull-up node, and control whether the gate driving signal output end is connected to the low level input end under the control of the pull-down node.

In some possible embodiments of the present disclosure, the output circuit includes:

a first output transistor, having a gate electrode connected to the pull-up node, a first electrode connected to the clock signal input end, and a second electrode connected to the gate driving signal output end; and

a second output transistor, having a gate electrode connected to the pull-down node, a first electrode connected to the gate driving signal output end, and a second electrode connected to the low level input end.

In some possible embodiments of the present disclosure, the pull-up node control circuit includes:

an input transistor, including a gate electrode and a first electrode both connected to the input end, and a second electrode connected to the pull-up node;

a reset transistor, including a gate electrode connected to the reset end, a first electrode connected to the pull-up node, and a second electrode connected to the low level input end; and

a pull-up node control transistor, including a gate electrode connected to the pull-down node, a first electrode connected to the pull-up node, and a second electrode connected to the low level input end.

In some possible embodiments of the present disclosure, the pull-down node control circuit includes:

a first control transistor, having a gate electrode and a first electrode both connected to a high level input end, and a second electrode connected to a pull-down control node;

a second control transistor, having a gate electrode connected to the pull-up node, a first electrode connected to the pull-down control node, and a second electrode connected to the low level input end;

a third control transistor, having a gate electrode connected to the pull-down control node, a first electrode connected to the high level input end, and a second electrode connected to the pull-down node; and

a fourth control transistor, having a gate electrode connected to the pull-up node, a first electrode connected to the pull-down node, and a second electrode connected to the low level input end,

wherein the storage capacitor circuit includes a storage capacitor, having a first end connected to the pull-up node, and a second end connected to the gate driving signal output end.

In a second aspect, a method for driving a gate driving circuitry is further provided according to embodiments of the present disclosure, which is applied in the above gate driving circuitry. Each display time of a frame image includes N display time periods sequentially set, N being an integer greater than 1, an n-th display time period corresponds to the n-th group of clock signal lines, and the n-th group of clock signal lines corresponds to the n-th gate driving unit, n being a positive integer less than or equal to N. The method for driving the gate driving circuitry includes:

inputting, by the 2a clock signal lines in the n-th group of clock signal lines, corresponding clock signals respectively; inputting low levels by clock signal lines in other groups of clock signal lines; and outputting, by each shift register module in the n-th gate driving unit, a gate driving signal according to the clock signals respectively inputted by the 2a clock signal lines in the n-th group of clock signal lines, where a is equal to 1 or an even number.

In some possible embodiments of the present disclosure, when each shift register module includes 2a shift register units that are sequentially cascaded, and each of the shift register units included in each shift register module in the n-th gate driving unit is correspondingly connected to one clock signal line in the n-th group of clock signal lines, the outputting, by each shift register module in the n-th gate driving unit, the gate driving signal according to the clock signals respectively inputted by the 2a clock signal lines in the n-th group of clock signal lines includes:

outputting, by each of the shift register units included in each shift register module in the n-th gate driving unit, the corresponding gate driving signal according to the clock signal inputted by the clock signal line connected to the shift register unit.

In some possible embodiments of the present disclosure, in the n-th display time period, a period of each of clock signals inputted into the 2a clock signal lines in the n-th group clock signal line is T, a duty ratio of each of the clock signals inputted into the 2a clock signal lines in the n-th group clock signal line is greater than or equal to 0.4 and is less than or equal to 0.5, and a clock signal inputted into a b-th clock signal line of the n-th group of clock signal lines is delayed by a time of T/2a than a clock signal inputted into a (b−1)-th clock signal line of the n-th group of clock signal lines, b being a positive integer greater than 1 and being less than or equal to 2a.

In some possible embodiments of the present disclosure, when a is equal to 1, and N is equal to 2, the gate driving circuitry includes a first gate driving unit, a second gate driving unit, a first group of clock signal lines, and a second group of clock signal lines, the first group of clock signal lines includes a first clock signal line and a second clock signal line, the second group of clock signal lines includes a third clock signal line and a fourth clock signal line, and the outputting, by each of the shift register units included in each shift register module in the n-th gate driving unit, the corresponding gate driving signal according to the clock signal inputted by the clock signal line connected to the shift register unit includes:

outputting, by a first shift register unit of each shift register module in the first gate driving unit, the corresponding gate driving signal according to the clock signal inputted by the first clock signal line;

outputting, by a second shift register unit of each shift register module in the first gate driving unit, the corresponding gate driving signal according to the clock signal inputted by the second clock signal line;

outputting, by the first shift register unit of each shift register module in the second gate driving unit, the corresponding gate driving signal according to the clock signal inputted by the third clock signal line; and

outputting, by the second shift register unit of each shift register module in the second gate driving unit, the corresponding gate driving signal according to the clock signal inputted by the fourth clock signal line.

In a third aspect, a display device is further provided according to embodiments of the present disclosure, which includes the above gate driving circuitry.

In some possible embodiments of the present disclosure, the display device according to the embodiments of the present disclosure further includes a clock signal control unit, and the clock signal control unit is connected to the N groups of clock signal lines, and is configured to control the clock signals inputted into the clock signal lines.

In some possible embodiments of the present disclosure, the display device according to the embodiments of the present disclosure further includes an integrated driving circuit, and the clock signal control unit is arranged in the integrated driving circuit.

### BRIEF DESCRIPTION OF THE DRAWINGS

In order to better clarify technical solutions in embodiments of the present disclosure or in the related art, drawings to be used in the descriptions of the embodiments will be briefly described hereinafter. Apparently, the drawings described hereinafter are only some drawings of the present disclosure, and other drawings can be obtained by persons of ordinary skill in the art based on these drawings without any creative effort.

FIG. 1 is a structural diagram of a conventional gate driving circuitry;

FIG. 2 is a structural diagram of a shift register module in a gate driving circuitry according to an embodiment of the present disclosure;

FIG. 3 is a structural diagram of a gate driving circuitry according to a specific embodiment of the present disclosure;

FIG. 4 is a timing diagram of signals provided by respective clock signal lines of the gate driving circuitry shown in FIG. 3 according to a specific embodiment of the present disclosure;

FIG. 5 is an operational timing diagram of a first shift register unit of the gate driving circuitry shown in FIG. 4 according to a specific embodiment of the present disclosure;

FIG. 6 is an operational timing diagram of a (N/2+1)-th shift register unit of the gate driving circuitry shown in FIG. 3 according to a specific embodiment of the present disclosure; and

FIG. 7 is a circuit diagram of a shift register unit in a gate drive circuit of the present disclosure according to a specific embodiment of the present disclosure.

### DETAILED DESCRIPTION

Technical solutions of embodiments of the present disclosure are illustrated clearly and completely in conjunction with drawings of the embodiments of the present disclosure. Apparently, the described embodiments are merely a part rather than all of the embodiments of the present disclosure. All other embodiments obtained by persons of ordinary skill in the art based on the embodiments of the present disclosure without creative efforts shall fall within the protection scope of the present disclosure.

Transistors used in all the embodiments of the present disclosure may each be a thin film transistor (TFT), or a field effect transistor (FET), or other component having the same characteristics. In the embodiments of the present disclosure, in order to distinguish two electrodes of each transistor except a gate electrode, one of the electrodes is referred to as a first electrode, and the other of the electrodes is referred to as a second electrode. In actual operation, the first electrode may be a drain electrode, and the second electrode may be a source electrode; or the first electrode may be the source electrode, and the second electrode may be the drain electrode.

FIG. 1 is a schematic diagram of a conventional GOA circuit including multiple stages of shift register units that are cascaded. The conventional GOA circuit is connected to a group of clock signal lines, and that is, all the shift register units included in a conventional GOA circuit are connected to the same group of clock signal lines. In FIG. 1, a first clock signal line is labeled as CLK1, a second clock signal line is labeled as CLK2, a first shift register unit is labeled as S1, a second shift register unit is labeled as S2, a (M−1)-th shift register unit is labeled as SM−1, a M-th shift register unit is labeled as SM, and M is an integer greater than 3. In FIG. 1, a gate driving signal output end of S1 is labeled as Output1, a gate driving signal output end of S2 is labeled as Output2, a gate driving signal output end of the SM−1 is labeled as OutputM−1, a gate driving signal output end of the SM is labeled as OutputM, an end labeled as CLK is a clock signal input end of the shift register unit, an end labeled as INPUT is an input end of the shift register unit, an end labeled as RESET is a reset end of the shift register unit, and an end labeled as STV is a start signal input end.

As can be seen from FIG. 1, CLK1 and CLK2 extend from the beginning of the GOA circuit to the end of the GOA circuit, the odd-numbered stages of shift register units are connected to CLK1, even-numbered stages of shift register units are connected to CLK2, and clock signals are supplied to CLK1 and CLK2 all the time during a frame display time. In the conventional GOA circuit shown in FIG. 1, power consumption P0 of all the clock signal lines is calculated by a formula: P0=2×(½×f×M/2×C×V²), where P is power consumption of CLK (a clock signal) of the GOA circuit, f is a frequency of the clock signal inputted to each clock signal line, M is the number of shift register units included in the GOA circuit, C is a capacitive load of each shift register unit applied onto the clock signal line connected to the shift register unit, and V is a voltage difference between a high voltage and a low voltage of the clock signal inputted to each clock signal line. The capacitive load of the shift register unit applied onto one of the clock signal lines connected thereto accounts for the vast majority of a capacitive load on the clock signal line, and an overlapping capacitance between the clock signal line and the other clock signal lines and an overlapping capacitance between the clock signal line and other signal lines account for only a small portion of the capacitive load on the clock signal line, and thus the overlapping capacitances are omitted from the above equation. It can be seen from the above formula that the clock signal line in the conventional GOA circuit consumes a large amount of power.

In an embodiment of the present disclosure, a gate driving circuitry includes N gate driving units and N groups of clock signal lines, and an n-th one of the gate driving units is correspondingly connected to an n-th group of clock signal lines, where N is an integer greater than 1, and n is a positive integer less than or equal to N. Each group of clock signal lines includes 2a clock signal lines, where a is equal to 1, or a is an even number; each of the gate driving units includes at least one shift register module; and each of the at least one shift register module included in the n-th gate driving unit is connected to the n-th group of clock signal lines.

In the embodiment of the present disclosure, the gate driving circuitry includes the N gate driving units and the N groups of clock signal lines, each of the gate driving units is correspondingly connected to one group of clock signal lines, and each group of clock signal lines is inputted with clock signals only in a corresponding time period and is inputted with low levels in other time periods. Accordingly, each group of clock signal lines operates in a time-division manner, and thus effectively reducing the power consumption of the gate driving circuitry.

The gate driving circuitry according to the embodiment of the present disclosure is applicable to display products of various sizes and under various scenarios, especially the display products with a high requirement on the power consumption such as mobile phones, tablet computers, and notebook computers.

In actual operation, each shift register module includes 2a shift register units that are sequentially cascaded, and each of the shift register units included in each shift register module in the n-th gate driving unit is correspondingly connected to one clock signal line in the n-th group of clock signal lines.

In a specific implementation, each shift register unit is configured to output a corresponding gate driving signal according to a clock signal inputted through a clock signal line connected to the shift register unit.

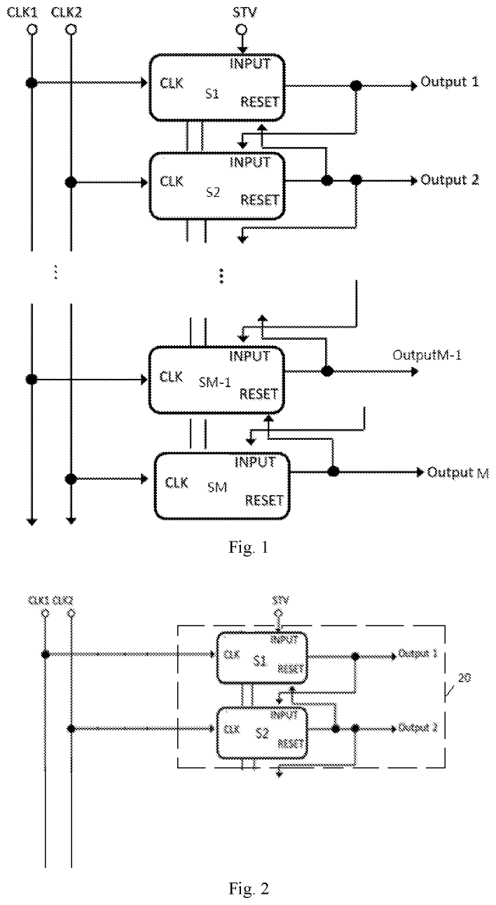

Specifically, as shown in FIG. 2, when a is equal to 1, a shift register module 20 includes a first shift register unit S1 and a second shift register unit S2, and a group of clock signal lines includes a first clock signal line CLK1 and a second clock signal line CLK2.

In FIG. 2, an end labeled as CLK is a clock signal input end, an end labeled as INPUT is an input end, an end labeled as RESET is a reset end, an end labeled as STV is a start signal input end, an end labeled as Output1 is a gate driving signal output end of S1, and an end labeled as Output2 is a gate driving signal output end of S2.

The clock signal input end of S1 is connected to the first clock signal line CLK1, and the clock signal input end of S2 is connected to the second clock signal line CLK2.

According to a specific embodiment, that a is equal to 1 and N is equal to 2 is taken as an example, the gate driving circuitry includes a first gate driving unit, a second gate driving unit, a first group of clock signal lines, and a second group of clock signal lines. The first group of clock signal lines includes a first clock signal line and a second clock signal line, and the second group of clock signal lines includes a third clock signal line and a fourth clock signal line. The first gate driving unit includes at least one shift register module, the second gate driving unit includes at least one shift register module, and each of the at least one shift register module includes a first shift register unit and a second shift register unit. The first shift register unit in each of the at least one shift register module of the first gate driving unit is connected to the first clock signal line, and the second shift register unit in each of the at least one shift register module of the first gate driving unit is connected to the second clock signal line. The first shift register unit in each of the at least one shift register module of the second gate driving unit is connected to the third clock signal line, and the second shift register unit in each of the at least one shift register module of the second gate driving unit is connected to the fourth clock signal line.

The gate driving circuitry provided by the embodiment of the present disclosure will be described below in specific embodiments.

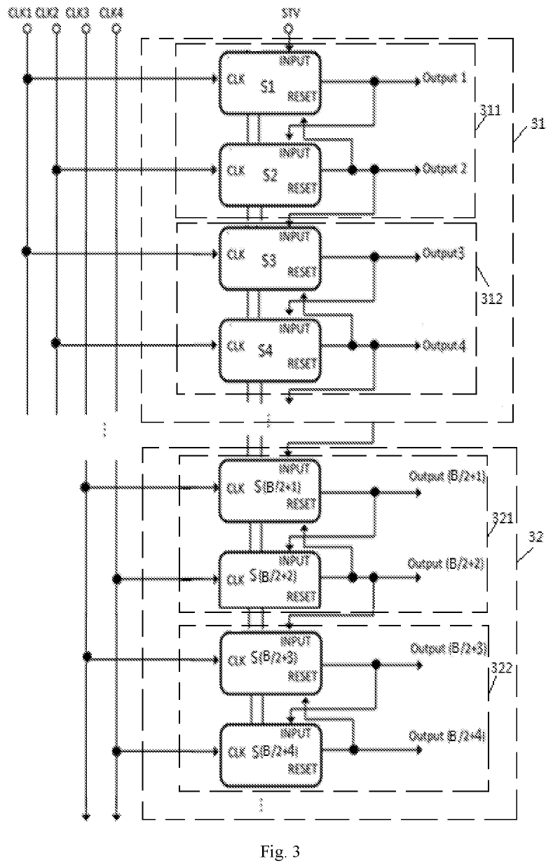

As shown in FIG. 3, a gate driving circuitry according to a specific embodiment of the present disclosure includes a first gate driving unit 31, a second gate driving unit 32, a first group of clock signal lines, and a second group of clock signal lines.

The first group of clock signal lines includes a first clock signal line CLK1 and a second clock signal line CLK2; and the second group of clock signal lines includes a third clock signal line CLK3 and a fourth clock signal line CLK4.

The first gate driving unit 31 includes B/4 shift register modules; the second gate driving unit 32 includes B/4 shift register modules; B/4 is an integer greater than 2; and B is the number of all shift register units contained in the gate drive circuit.

The first shift register module 311 of the first gate driving unit 31 includes a first shift register unit S1 and a second shift register unit S2.

The second shift register module 312 of the first gate driving unit 31 includes a third shift register unit S3 and a fourth shift register unit S4.

The first shift register module 321 of the second gate driving unit 32 (that is, a (B/4+1)-th shift register module of the gate driving circuitry) includes a (B/2+1)-th shift register unit S(B/2+1) and a (B/2+2)-th shift register unit S(B/2+2).

The second shift register module 322 of the second gate driving unit 32 (that is, a (B/4+2)-th shift register module of the gate driving circuitry) includes a (B/2+3)-th shift register unit S(B/2+3) and a (B/2+4)-th shift register unit S(B/2+4).

As shown in FIG. 2, an end labeled as CLK is a clock signal input end of each shift register unit, an end labeled as INPUT is an input end, an end labeled as RESET is a reset end, and an end labeled as STV is a start signal input end. A gate driving signal output end of S1 is labeled as Output1, a gate driving signal output end of S2 is labeled as Output2, a gate driving signal output end of S3 is labeled as Output3, a gate driving signal output end of S4 is labeled as Output4, a gate driving signal output end of S(B/2+1) is labeled as Output(B/2+1), a gate driving signal output end of S(B/2+2) is labeled as Output(B/2+2), a gate driving signal output end of S(B/2+3) is labeled as Output(B/2+3), and a gate driving signal output end of S(B/2+4) is labeled as Output(B/2+4).

Compared with the conventional gate driving circuitry, on the basis of the original first clock signal line CLK1 and the original second clock signal line CLK2, the second group of clock signal lines is added into the gate driving circuitry according to the specific embodiment of the present disclosure as shown in FIG. 3, and the second group of clock signal lines includes the third clock signal line CLK3 and the fourth clock signal line CLK4. The first clock signal line CLK1 and the second clock signal line CLK2 are only connected to the first half of the shift register units (including the first shift register unit S1 to the (B/2)-th shift register unit), and the third clock signal line CLK3 and the fourth clock signal line CLK4 are only connected to the latter half of the shift register units (including the (B/2+1)-th shift register unit S(B/2+1) to the B-th shift register unit). In the first half of a display time of a frame image, since the shift register units connected to the third clock signal line CLK3 and the fourth clock signal line CLK4 do not need to operate, clock signals only need to be supplied to the first clock signal line CLK1 and the second clock signal line CLK2, and are not needed to be supplied to the third clock signal line CLK3 and the fourth clock signal line CLK4, and the third clock signal line CLK3 and the fourth clock signal line CLK4 may be supplied with low levels. Similarly, in the latter half of the display time of the frame image, the clock signals only need to be supplied to the third clock signal line CLK3 and the fourth clock signal line CLK4, and are not needed to be supplied to the first clock signal line CLK1 and the second clock signal line CLK2, and the first clock signal line CLK1 and the second clock signal line CLK2 may be supplied with low levels.

A calculation formula of power consumption P of all the clock signal lines in the gate driving circuitry shown in FIG. 3 in the present disclosure is as follows: P=4×(½×f/2×B/4×C×V²), where f is a frequency of the clock signal inputted to each clock signal line, B is the total number of the shift register units contained in the gate drive circuit as shown in FIG. 2 in the present disclosure, C is a capacitive load of each shift register unit applied onto the clock signal line connected to the shift register unit, and V is a voltage difference between a high voltage and a low voltage of the clock signal inputted to each clock signal line. The operating frequency “f/2” in the above formula is because the operating time of each clock signal line is only one half of the display time of one frame image, which is equivalent to the operating frequency reducing to one half of f Compared with the conventional gate driving circuitry, the power consumption of CLK of the gate drive circuit according to the embodiment of the present disclosure may be reduced by half.

In the embodiment of the present disclosure, for the gate driving circuitry shown in FIG. 2, two groups of clock signal lines are adopted to operate in a time division manner, so as to achieve the objective of reducing the power consumption of the gate driving circuitry.

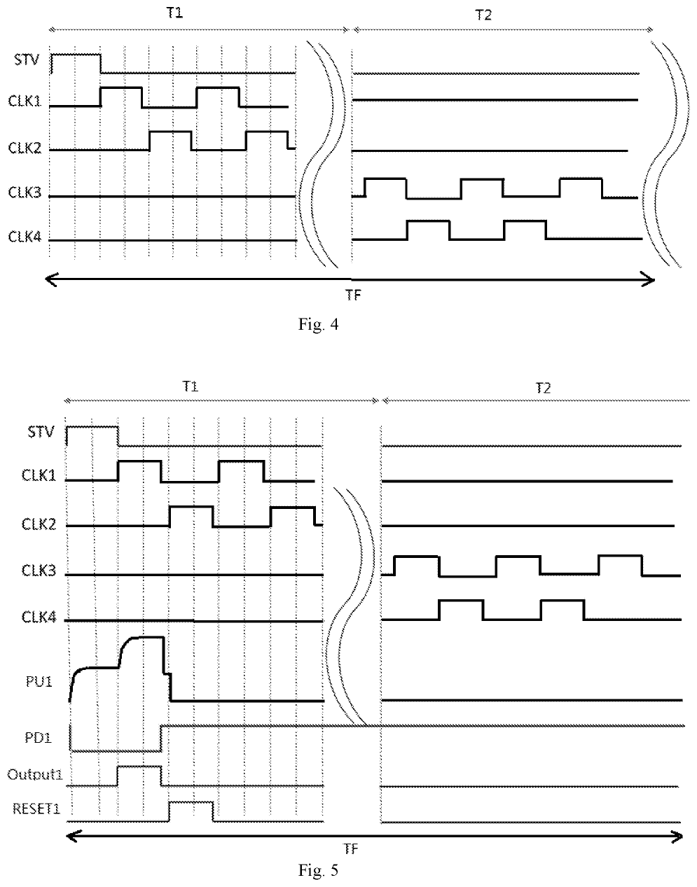

As shown in FIG. 4, a high level is inputted into STV at the beginning of one frame display time TF, and the one frame display time TF includes a first display time period T1 and a second display time period T2 which are sequentially set.

During the first display time period T1, clock signals are supplied to CLK1 and CLK2, and low level signals are supplied to CLK3 and CLK4.

During the second display time period T2, clock signals are supplied to CLK3 and CLK4, and low level signals are supplied to CLK1 and CLK2.

As shown in FIG. 4, a duty ratio of the clock signal supplied to each clock signal line may be slightly smaller than ½ to prevent the shift register units in adjacent stages from simultaneously outputting high levels. For example, the duty ratio of the clock signal supplied to each clock signal line may be 0.45. Those skilled in the art will appreciate that a value of the duty ratio depends on the characteristics of the gate drive circuit.

As shown in FIG. 5, reference sign PU1 represents a pull-up node in the first shift register unit of the gate driving circuitry shown in FIG. 2 of the present disclosure, reference sign PD1 represents a pull-down node in the first shift register unit, reference sign Output1 represents the gate driving signal output end of the first shift register unit, and reference sign RESET1 represents a signal inputted into the reset end of the gate driving signal output end of the first shift register unit.

As shown in FIG. 5, during the first display time period T1, which is a display time period after STV inputs a high level signal, Output1 outputs a high level, and the first shift register unit operates. At this time, only CLK1 and CLK2 are supplied with clock signals, and CLK3 and CLK4 are supplied with low level signals.

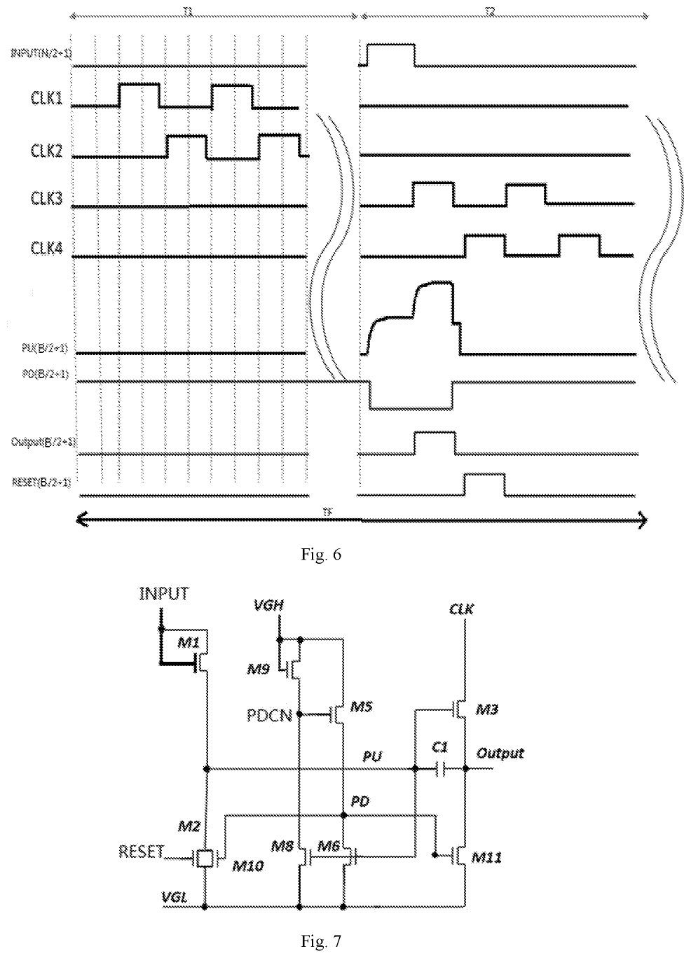

As shown in FIG. 6, reference sign INPUT(B/2+1) represents an input end of the (B/2+1)-th shift register unit of the gate driving circuitry shown in FIG. 3 in the present disclosure, reference sign PU(B/2+1) represents a pull-up node in the (B/2+1)-th shift register unit in the gate driving circuitry shown in FIG. 3 in the present disclosure, reference sign PD(B/2+1) represents a pull-down node in the (B/2+1)-th shift register unit, reference sign Output(B/2+1) represents a gate driving signal output end of the (B/2+1)-th shift register unit, and reference sign RESET(B/2+1) represents a signal inputted into the reset end of the gate driving signal output end of the (B/2+1)-th shift register unit.

As shown in FIG. 6, during the second display time period T2, which is a display time period after a high level signal is inputted into INPUT(B/2+1), Output(B/2+1) outputs a high level, and the (B/2+1)-th shift register unit operates. At this time, only CLK3 and CLK4 are supplied with clock signals, and CLK1 and CLK2 are supplied with low level signals.

In actual operation, one group of clock signal lines may also include four clock signal lines, or eight clock signal lines.

In actual operation, the gate driving circuitry according to the embodiment of the present disclosure may also include at least three shift register modules.

Specifically, each shift register unit may include:

a pull-up node control circuit, that is respectively connected to an input end, a reset end, a pull-up node and a pull-down node, and is configured to control a potential of the pull-up node under the control of the input end, the reset end and the pull-down node;

a pull-down node control circuit, that is respectively connected to a high-level input end, the pull-up node, and the pull-down node, and is configured to control a potential of the pull-down node under the control of the pull-up node;

a storage capacitor circuit, having a first end connected to the pull-up node, and a second end connected to a gate driving signal input end; and

an output circuit, that is respectively connected to the pull-up node, the pull-down node, a clock signal input end, a low level input end, and a gate driving signal output end, and is configured to control whether the gate driving signal output end is connected to the clock signal input end under the control of the pull-up node, and control whether the gate driving signal output end is connected to the low level input end under the control of the pull-down node.

In actual operation, the clock signal input end is connected to the clock signal line.

Specifically, the output circuit may include:

a first output transistor, having a gate electrode connected to the pull-up node, a first electrode connected to the clock signal input end, and a second electrode connected to the gate driving signal output end; and

a second output transistor, having a gate electrode connected to the pull-down node, a first electrode connected to the gate driving signal output end, and a second electrode connected to the low level input end.

Specifically, the pull-up node control circuit may include:

an input transistor, including a gate electrode and a first electrode both connected to the input end, and a second electrode connected to the pull-up node;

a reset transistor, including a gate electrode connected to the reset end, a first electrode connected to the pull-up node, and a second electrode connected to the low level input end; and

a pull-up node control transistor, including a gate electrode connected to the pull-down node, a first electrode connected to the pull-up node, and a second electrode connected to the low level input end.

Specifically, the pull-down node control circuit may include:

a first control transistor, having a gate electrode and a first electrode both connected to a high level input end, and a second electrode connected to a pull-down control node;

a second control transistor, having a gate electrode connected to the pull-up node, a first electrode connected to the pull-down control node, and a second electrode connected to the low level input end;

a third control transistor, having a gate electrode connected to the pull-down control node, a first electrode connected to the high level input end, and a second electrode connected to the pull-down node; and

a fourth control transistor, having a gate electrode connected to the pull-up node, a first electrode connected to the pull-down node, and a second electrode connected to the low level input end,

wherein the storage capacitor circuit includes a storage capacitor, having a first end connected to the pull-up node, and a second end connected to the gate driving signal output end.

As shown in FIG. 7, according to a specific embodiment, each shift register unit included in the gate driving circuitry provided by the above embodiments of the present disclosure includes a pull-up node control circuit, a pull-down node control circuit, a storage capacitor circuit, and an output circuit.

The output circuit includes:

a first output transistor M3, having a gate electrode connected to a pull-up node PU, a drain electrode connected to a clock signal input end CLK, and a source electrode connected to a gate driving signal output end Output; and

a second output transistor M11, having a gate electrode connected to a pull-down node PD, a drain electrode connected to the gate driving signal output end Output, and a source electrode connected to a low level input end where a low level VGL is inputted.

The pull-up node control circuit includes:

an input transistor M1, having a gate electrode and a drain electrode both connected to an input end INPUT, and a source electrode connected to the pull-up node PU;

a reset transistor M2, having a gate electrode connected to the reset end RESET, a drain electrode connected to the pull-up node PU, and a source electrode connected to the low level input end where the low level VGL is inputted; and

a pull-up node control transistor M10, having a gate electrode connected to the pull-down node PD, a drain electrode connected to the pull-up node PU, and a source electrode connected to the low level input end where the low level VGL is inputted.

The pull-down node control circuit includes:

a first control transistor M9, having a gate electrode and a drain electrode both connected to a high level input end where a high level VGH is inputted, and a source electrode connected to a pull-down control node PDCN;

a second control transistor M8, having a gate electrode connected to the pull-up node PU, a drain electrode connected to the pull-down control node PDCN, and a source electrode connected to the low level input end where the low level VGL is inputted;

a third control transistor M5, having a gate electrode connected to the pull-down control node PDCN, a drain electrode connected to the high level input end where the high level VGH is inputted, and a source electrode connected to the pull-down node PD; and

a fourth control transistor M6, having a gate electrode connected to the pull-up node PU, a drain electrode connected to the pull-down node PD, and a source electrode connected to the low level input end where the low level VGL is inputted,

wherein the storage capacitor circuit includes: a storage capacitor C1, its first end is connected to the pull-up node PU, and its second end is connected to the gate driving signal output end Output.

A method for driving a gate driving circuitry is provided according to an embodiment of the present disclosure, which is applied to the above gate driving circuitry. Each display time of a frame image includes N display time periods sequentially set, N being an integer greater than 1, an n-th display time period corresponds to the n-th group of clock signal lines, and the n-th group of clock signal lines corresponds to the n-th gate driving unit, n being a positive integer less than or equal to N. The method for driving the gate driving circuitry includes:

inputting, by the 2a clock signal lines in the n-th group of clock signal lines, corresponding clock signals respectively; inputting low levels by clock signal lines in other groups of clock signal lines; and outputting, by each shift register module in the n-th gate driving unit, a gate driving signal according to the clock signals respectively inputted by the 2a clock signal lines in the n-th group of clock signal lines, where a is equal to 1 or an even number.

Specifically, when each shift register module includes 2a shift register units that are sequentially cascaded, and each of the shift register units included in each shift register module in the n-th gate driving unit is correspondingly connected to one clock signal line in the n-th group of clock signal lines, the outputting, by each shift register module in the n-th gate driving unit, the gate driving signal according to the clock signals respectively inputted by the 2a clock signal lines in the n-th group of clock signal lines includes:

outputting, by each of the shift register units included in each shift register module in the n-th gate driving unit, the corresponding gate driving signal according to the clock signal inputted by the clock signal line connected to the shift register unit.

In a specific implementation, in the n-th display time period, a period of each of clock signals inputted into the 2a clock signal lines in the n-th group clock signal line is T, a duty ratio of each of the clock signals inputted into the 2a clock signal lines in the n-th group clock signal line is greater than or equal to 0.4 and is less than or equal to 0.5, and a clock signal inputted into a b-th clock signal line of the n-th group of clock signal lines is delayed by a time of T/2a than a clock signal inputted into a (b−1)-th clock signal line of the n-th group of clock signal lines, b being a positive integer greater than 1 and being less than or equal to 2a. In such manner, a turning-on time of a certain clock signal line of the n-th group of clock signal lines is T/2a later than another turning-on time of immediately previous one clock signal line relative to the certain clock signal line of the n-th group of clock signal lines, and thus every stages of shift register units connected to the clock signal lines in the n-th group of clock signal lines are turned on in sequence.

In actual operation, in order to prevent the adjacent stages of shift register units from simultaneously outputting high levels, the duty ratio of the clock signal may be set to be slightly less than 0.5.

According to a specific embodiment, in a case that a is equal to 1, and N is equal to 2, the gate driving circuitry includes a first gate driving unit, a second gate driving unit, a first group of clock signal lines, and a second group of clock signal lines, the first group of clock signal lines includes a first clock signal line and a second clock signal line, and the second group of clock signal lines includes a third clock signal line and a fourth clock signal line. In this case, the outputting, by each of the shift register units included in each shift register module in the n-th gate driving unit, the corresponding gate driving signal according to the clock signal inputted by the clock signal line connected to the shift register unit includes:

outputting, by a first shift register unit of each shift register module in the first gate driving unit, the corresponding gate driving signal according to the clock signal inputted by the first clock signal line;

outputting, by a second shift register unit of each shift register module in the first gate driving unit, the corresponding gate driving signal according to the clock signal inputted by the second clock signal line;

outputting, by the first shift register unit of each shift register module in the second gate driving unit, the corresponding gate driving signal according to the clock signal inputted by the third clock signal line; and

outputting, by the second shift register unit of each shift register module in the second gate driving unit, the corresponding gate driving signal according to the clock signal inputted by the fourth clock signal line.

A display device is provided according to an embodiment of the present disclosure, which includes the above gate driving circuitry.

Specifically, the display device according to the embodiment of the present disclosure may include a clock signal control unit, and the clock signal control unit is connected to the N groups of clock signal lines, and is configured to control the clock signals to be inputted into the clock signal lines.

Specifically, the display device according to the embodiment of the present disclosure may further include an integrated driving circuit, and the clock signal control unit is arranged in the integrated driving circuit.

The display device provided by the embodiment of the present disclosure may be any product or component having a display function, such as a mobile phone, a tablet computer, a television, a display, a notebook computer, a digital photo frame, a navigator, and the like.

The foregoing embodiments are illustrative embodiments of the present disclosure. It should be noted that those skilled in the art can also make numerous improvements and polishments without departing from the principle of the present disclosure, and these improvements and polishments shall fall within the protection scope of the present disclosure.

1. A gate driving circuitry, comprising: N gate driving units and N groups of clock signal lines, wherein an n-th one of the gate driving units is correspondingly connected to an n-th group of clock signal lines, where N is an integer greater than 1, and n is a positive integer less than or equal to N;
each group of clock signal lines comprises 2a clock signal lines, where a is equal to 1, or a is an even number;
each of the gate driving units comprises at least one shift register module; and
each of the at least one shift register module comprised in the n-th gate driving unit is connected to the n-th group of clock signal lines.

2. The circuitry according to claim 1, wherein each shift register module comprises 2a shift register units that are sequentially cascaded, and each of the shift register units comprised in each shift register module in the n-th gate driving unit is correspondingly connected to one clock signal line in the n-th group of clock signal lines.

3. The circuitry according to claim 2, wherein each shift register unit is configured to output a corresponding gate driving signal according to a clock signal inputted by the clock signal line connected to the shift register unit.

4. The circuitry according to claim 1, wherein a is equal to 1, and N is equal to 2,
the gate driving circuitry comprises a first gate driving unit, a second gate driving unit, a first group of clock signal lines, and a second group of clock signal lines;
the first group of clock signal lines comprises a first clock signal line and a second clock signal line, and the second group of clock signal lines comprises a third clock signal line and a fourth clock signal line;
the first gate driving unit comprises at least one shift register module, the second gate driving unit comprises at least one shift register module, and each of the at least one shift register module comprises a first shift register unit and a second shift register unit;
the first shift register unit in each of the at least one shift register module of the first gate driving unit is connected to the first clock signal line, and the second shift register unit in each of the at least one shift register module of the first gate driving unit is connected to the second clock signal line; and
the first shift register unit in each of the at least one shift register module of the second gate driving unit is connected to the third clock signal line, and the second shift register unit in each of the at least one shift register module of the second gate driving unit is connected to the fourth clock signal line.

5. The circuitry according to claim 2, wherein each shift register unit comprises:
a pull-up node control circuit, that is respectively connected to an input end, a reset end, a pull-up node and a pull-down node, and is configured to control a potential of the pull-up node under the control of the input end, the reset end and the pull-down node;
a pull-down node control circuit, that is respectively connected to a high-level input end, the pull-up node, and the pull-down node, and is configured to control a potential of the pull-down node under the control of the pull-up node;
a storage capacitor circuit, having a first end connected to the pull-up node, and a second end connected to a gate driving signal input end; and
an output circuit, that is respectively connected to the pull-up node, the pull-down node, a clock signal input end, a low level input end, and a gate driving signal output end, and is configured to control whether the gate driving signal output end is connected to the clock signal input end under the control of the pull-up node, and control whether the gate driving signal output end is connected to the low level input end under the control of the pull-down node.

6. The circuitry according to claim 5, wherein the output circuit comprises:
a first output transistor, having a gate electrode connected to the pull-up node, a first electrode connected to the clock signal input end, and a second electrode connected to the gate driving signal output end; and
a second output transistor, having a gate electrode connected to the pull-down node, a first electrode connected to the gate driving signal output end, and a second electrode connected to the low level input end.

7. The circuitry according to claim 5, wherein the pull-up node control circuit comprises:
an input transistor, comprising a gate electrode and a first electrode both connected to the input end, and a second electrode connected to the pull-up node;
a reset transistor, comprising a gate electrode connected to the reset end, a first electrode connected to the pull-up node, and a second electrode connected to the low level input end; and
a pull-up node control transistor, comprising a gate electrode connected to the pull-down node, a first electrode connected to the pull-up node, and a second electrode connected to the low level input end.

8. The circuitry according to claim 5, wherein the pull-down node control circuit comprises:
a first control transistor, having a gate electrode and a first electrode both connected to a high level input end, and a second electrode connected to a pull-down control node;
a second control transistor, having a gate electrode connected to the pull-up node, a first electrode connected to the pull-down control node, and a second electrode connected to the low level input end;
a third control transistor, having a gate electrode connected to the pull-down control node, a first electrode connected to the high level input end, and a second electrode connected to the pull-down node; and
a fourth control transistor, having a gate electrode connected to the pull-up node, a first electrode connected to the pull-down node, and a second electrode connected to the low level input end,
wherein the storage capacitor circuit comprises a storage capacitor, having a first end connected to the pull-up node, and a second end connected to the gate driving signal output end.

9. A method for driving the gate driving circuitry according to claim 1, wherein each display time of a frame image comprises N display time periods sequentially set, N being an integer greater than 1, an n-th display time period corresponds to the n-th group of clock signal lines, and the n-th group of clock signal lines corresponds to the n-th gate driving unit, n being a positive integer less than or equal to N;
the method comprising: in the n-th display time period,
inputting, by the 2a clock signal lines in the n-th group of clock signal lines, corresponding clock signals respectively;
inputting low levels by clock signal lines in other groups of clock signal lines; and
outputting, by each shift register module in the n-th gate driving unit, a gate driving signal according to the clock signals respectively inputted by the 2a clock signal lines in the n-th group of clock signal lines, where a is equal to 1 or an even number.

10. The method according to claim 9, wherein when each shift register module comprises 2a shift register units that are sequentially cascaded, and each of the shift register units comprised in each shift register module in the n-th gate driving unit is correspondingly connected to one clock signal line in the n-th group of clock signal lines, the outputting, by each shift register module in the n-th gate driving unit, the gate driving signal according to the clock signals respectively inputted by the 2a clock signal lines in the n-th group of clock signal lines comprises:
outputting, by each of the shift register units comprised in each shift register module in the n-th gate driving unit, the corresponding gate driving signal according to the clock signal inputted by the clock signal line connected to the shift register unit.

11. The method according to claim 9, wherein in the n-th display time period, a period of each of clock signals inputted into the 2a clock signal lines in the n-th group clock signal line is T, a duty ratio of each of the clock signals inputted into the 2a clock signal lines in the n-th group clock signal line is greater than or equal to 0.4 and is less than or equal to 0.5, and a clock signal inputted into a b-th clock signal line of the n-th group of clock signal lines is delayed by a time of T/2a than a clock signal inputted into a (b−1)-th clock signal line of the n-th group of clock signal lines, b being a positive integer greater than 1 and being less than or equal to 2a.

12. The method according to claim 10, wherein when a is equal to 1, and N is equal to 2, the gate driving circuitry comprises a first gate driving unit, a second gate driving unit, a first group of clock signal lines, and a second group of clock signal lines, the first group of clock signal lines comprises a first clock signal line and a second clock signal line, the second group of clock signal lines comprises a third clock signal line and a fourth clock signal line, and the outputting, by each of the shift register units comprised in each shift register module in the n-th gate driving unit, the corresponding gate driving signal according to the clock signal inputted by the clock signal line connected to the shift register unit comprises:
outputting, by a first shift register unit of each shift register module in the first gate driving unit, the corresponding gate driving signal according to the clock signal inputted by the first clock signal line;
outputting, by a second shift register unit of each shift register module in the first gate driving unit, the corresponding gate driving signal according to the clock signal inputted by the second clock signal line;
outputting, by the first shift register unit of each shift register module in the second gate driving unit, the corresponding gate driving signal according to the clock signal inputted by the third clock signal line; and
outputting, by the second shift register unit of each shift register module in the second gate driving unit, the corresponding gate driving signal according to the clock signal inputted by the fourth clock signal line.

13. A display device, comprising the gate driving circuitry according to claim 1.

14. The display device according to claim 13, further comprising: a clock signal control unit, wherein the clock signal control unit is connected to the N groups of clock signal lines, and is configured to control the clock signals inputted into the clock signal lines.

15. The display device according to claim 14, further comprising an integrated driving circuit, wherein the clock signal control unit is arranged in the integrated driving circuit.

16. The display device according to claim 13, wherein each shift register module comprises 2a shift register units that are sequentially cascaded, and each of the shift register units comprised in each shift register module in the n-th gate driving unit is correspondingly connected to one clock signal line in the n-th group of clock signal lines,
wherein each shift register unit is configured to output a corresponding gate driving signal according to a clock signal inputted by the clock signal line connected to the shift register unit.

17. The display device according to claim 13, wherein a is equal to 1, and N is equal to 2,
the gate driving circuitry comprises a first gate driving unit, a second gate driving unit, a first group of clock signal lines, and a second group of clock signal lines;
the first group of clock signal lines comprises a first clock signal line and a second clock signal line, and the second group of clock signal lines comprises a third clock signal line and a fourth clock signal line;
the first gate driving unit comprises at least one shift register module, the second gate driving unit comprises at least one shift register module, and each of the at least one shift register module comprises a first shift register unit and a second shift register unit;
the first shift register unit in each of the at least one shift register module of the first gate driving unit is connected to the first clock signal line, and the second shift register unit in each of the at least one shift register module of the first gate driving unit is connected to the second clock signal line; and
the first shift register unit in each of the at least one shift register module of the second gate driving unit is connected to the third clock signal line, and the second shift register unit in each of the at least one shift register module of the second gate driving unit is connected to the fourth clock signal line.

18. The display device according to claim 16, wherein each shift register unit comprises:
a pull-up node control circuit, that is respectively connected to an input end, a reset end, a pull-up node and a pull-down node, and is configured to control a potential of the pull-up node under the control of the input end, the reset end and the pull-down node;
a pull-down node control circuit, that is respectively connected to a high-level input end, the pull-up node, and the pull-down node, and is configured to control a potential of the pull-down node under the control of the pull-up node;
a storage capacitor circuit, having a first end connected to the pull-up node, and a second end connected to a gate driving signal input end; and
an output circuit, that is respectively connected to the pull-up node, the pull-down node, a clock signal input end, a low level input end, and a gate driving signal output end, and is configured to control whether the gate driving signal output end is connected to the clock signal input end under the control of the pull-up node, and control whether the gate driving signal output end is connected to the low level input end under the control of the pull-down node.

19. The display device according to claim 18, wherein the output circuit comprises:
a first output transistor, having a gate electrode connected to the pull-up node, a first electrode connected to the clock signal input end, and a second electrode connected to the gate driving signal output end; and
a second output transistor, having a gate electrode connected to the pull-down node, a first electrode connected to the gate driving signal output end, and a second electrode connected to the low level input end,
wherein the pull-up node control circuit comprises:
an input transistor, comprising a gate electrode and a first electrode both connected to the input end, and a second electrode connected to the pull-up node;
a reset transistor, comprising a gate electrode connected to the reset end, a first electrode connected to the pull-up node, and a second electrode connected to the low level input end; and
a pull-up node control transistor, comprising a gate electrode connected to the pull-down node, a first electrode connected to the pull-up node, and a second electrode connected to the low level input end,
wherein the pull-down node control circuit comprises:
a first control transistor, having a gate electrode and a first electrode both connected to a high level input end, and a second electrode connected to a pull-down control node;
a second control transistor, having a gate electrode connected to the pull-up node, a first electrode connected to the pull-down control node, and a second electrode connected to the low level input end;
a third control transistor, having a gate electrode connected to the pull-down control node, a first electrode connected to the high level input end, and a second electrode connected to the pull-down node; and
a fourth control transistor, having a gate electrode connected to the pull-up node, a first electrode connected to the pull-down node, and a second electrode connected to the low level input end,
wherein the storage capacitor circuit comprises a storage capacitor, having a first end connected to the pull-up node, and a second end connected to the gate driving signal output end.

20. The display device according to claim 13, wherein the gate driving circuitry is a Gate Driver On Array (GOA) circuitry.
